(19) United States
(12) Patent Application Publication
(10) Pub. No.: US 2018/0244274 A1
(43) Pub. Date: Aug. 30, 2018

(54) CONTROL DEVICE FOR VEHICLE

(71) Applicant: TOYOTA JIDOSHA KABUSHIKI KAISHA, Toyota-shi (JP)

(72) Inventor: Akihiro KATAYAMA, Toyota-shi (JP)

(73) Assignee: TOYOTA JIDOSHA KABUSHIKI KAISHA, Toyota-shi (JP)

(21) Appl. No.: 15/842,134

(22) Filed: Dec. 14, 2017

(30) Foreign Application Priority Data
Feb. 28, 2017 (JP) 2017-037508

(51) Int. Cl. B60W 30/184

(52) U.S. Cl. CPC B60W 30/184; B60W 2030/206

(57) ABSTRACT

A control device for a vehicle includes a resonance suppressor configured to control any one of a temperature increase process, a slip amount of a lock-up clutch, and a gear position of a transmission to execute a resonance suppression process suppressing resonance of an internal combustion engine and the transmission caused by execution of the temperature increase process, when the temperature increase process is requested, when the lock-up clutch is in the engaged state, and when rotational speed of the internal combustion engine falls in a resonance region in which the internal combustion engine resonates with the transmission if the temperature increase process is executed.

### CROSS-REFERENCE TO RELATED APPLICATION

This application is based upon and claims the benefit of priority of the prior Japanese Patent Application No. 2017-037508, filed on Feb. 28, 2017, the entire contents of which are incorporated herein by reference.

### FIELD OF THE INVENTION

The present invention relates to a control device for a vehicle.

### BACKGROUND

There is known an increase temperature process that controls an air-fuel ratio of one of plural cylinders of an internal combustion engine to be a rich air-fuel ratio and controls air-fuel ratios of the other cylinders to be lean air-fuel ratios, in order to increase a temperature of a catalyst for purifying exhaust gas from the internal combustion engine (See, for example, Japanese Laid-Open Patent Publication No. 2012-057492).

Further, a vehicle with an internal combustion engine is equipped with a fluid transmission device having a lock-up clutch for switching an engaged state and a released state to control power transmission from the internal combustion engine to a transmission.

Since the air-fuel ratio varies among the cylinders in the above-described temperature increase process, an increase in a fluctuation amount of the rotational speed of the internal combustion engine might increase vibration of the internal combustion engine. If the lock-up clutch is in the engaged state in this case, the internal combustion engine might resonate with the transmission and the vibration might increase, so that drivability might deteriorate, as depending on the rotational speed of the internal combustion engine.

### SUMMARY OF THE INVENTION

It is therefore an object of the present invention to provide a control device for a vehicle in which deterioration in drivability is suppressed.

The above object is achieved by a control device for a vehicle, the vehicle including an internal combustion engine, a transmission disposed on a power transmission path between the internal combustion engine and a driving wheel, a fluid transmission device including a lock-up clutch switching between an engaged state and a released state to control power transmission from the internal combustion engine to the transmission, and a catalyst for purifying exhaust gas from the internal combustion engine, the control device including: a temperature-increase request determinator configured to determinate whether or not to request a temperature increase process that increases a temperature of the catalyst by controlling an air-fuel ratio in at least one cylinder of a plurality of cylinders of the internal combustion engine to be a rich air-fuel ratio smaller than a stoichiometric air-fuel ratio and by controlling an air-fuel ratio in a cylinder other than the at least one cylinder to be a lean air-fuel ratio greater than the stoichiometric air-fuel ratio; an engagement state determinator configured to determine whether or not the lock-up clutch is in the engaged state; a driving state determinator configured to determine whether or not rotational speed of the internal combustion engine falls in a resonance region in which the internal combustion engine resonates with the transmission if the temperature increase process is executed, when an affirmative determination is made by the engagement state determinator; and a resonance suppressor configured to control any one of the temperature increase process, a slip amount of the lock-up clutch, and a gear position of the transmission to execute a resonance suppression process suppressing resonance of the internal combustion engine and the transmission caused by execution of the temperature increase process, when affirmative determinations are made by the temperature-increase request determinator, the engagement state determinator, and the driving state determinator.

The resonance of the internal combustion engine and the transmission caused by execution of the temperature increase process is suppressed, thereby suppressing deterioration in drivability.

The resonance suppress process may be any one of a process that prohibits execution of the temperature increase process, a process that decreases a difference between the rich air-fuel ratio and the lean air-fuel ratio as compared with the released state and executes the temperature increase process, and a process that changes a combination of the plurality of the cylinders in which the rich air-fuel ratio and the lean air-fuel ratio are respectively achieved and executes the temperature increase process such that a vibration frequency of the internal combustion engine caused by the execution of the temperature increase process deviates from a resonance point of the internal combustion engine.

The temperature increase process is prohibited, thereby suppressing the resonance. Further, a difference between the rich air-fuel ratio and the lean air-fuel ratio decreases as compared with the released state and the temperature increase process is executed, thereby suppressing the vibration of the internal combustion engine caused by the execution of the temperature increase process and suppressing the resonance. A combination of the plurality of the cylinders, in which the rich air-fuel ratio and the lean air-fuel ratio are respectively achieved in the released state and in the temperature increase process, is changed and the temperature increase process is executed, so that a vibration frequency of the internal combustion engine deviates from a resonance point of the internal combustion engine by executing the temperature increase process, thereby suppressing the resonance.

The resonance suppress process may be a process that increases the slip amount of the lock-up clutch, as compared with a slip amount in which the resonance suppress process is not executed, and executes the temperature increase process.

The slip amount of the lock-up clutch is increased, so that the vibration is suppressed from being transmitted from the internal combustion engine to the transmission, thereby suppressing the resonance.

The resonance suppress process may be a process that changes a gear position of the transmission and executes the temperature increase process such that rotational speed of the internal combustion engine deviates from the resonance region.

The gear position of the transmission is changed such that rotational speed of the internal combustion engine deviates from the resonance region, thereby suppressing the resonance.

The resonance region may be different according to a gear position of the transmission.

The resonance region may be expanded as a load of the internal combustion engine increases.

The engagement state may include a fully engaged state and a slip engaged state and, the resonance region may be larger in the fully engaged state than in the slip engagement state.

### BRIEF DESCRIPTION OF THE DRAWINGS

FIG. 1 is a schematic configuration view around an engine in a vehicle;

FIG. 2 is a schematic configuration view around an automatic transmission of the vehicle;

FIG. 3A and FIG. 3B are graphs illustrating a vibration transmission rate from the engine to the automatic transmission with respect to a vibration frequency of the engine in a fully engaged state and in a slip engaged state, respectively;

FIG. 4 is a flowchart illustrating temperature increase control in the present embodiment;

FIG. 5A and FIG. 5B are example of maps defining resonance regions;

FIG. 6A to FIG. 6C are maps defining resonance regions corresponding to loads of the engine in the fully engaged state;

FIG. 7A to FIG. 7C are maps defining resonance regions corresponding to the loads of the engine in the slip engaged state;

FIG. 8 is a flowchart illustrating temperature increase control in the second variation;

FIG. 9 is a flowchart illustrating temperature increase control in the third variation;

FIG. 10 is a flowchart illustrating temperature increase control in the fourth variation; and

FIG. 11 is a flowchart illustrating temperature increase control in the fifth variation.

### DETAILED DESCRIPTION

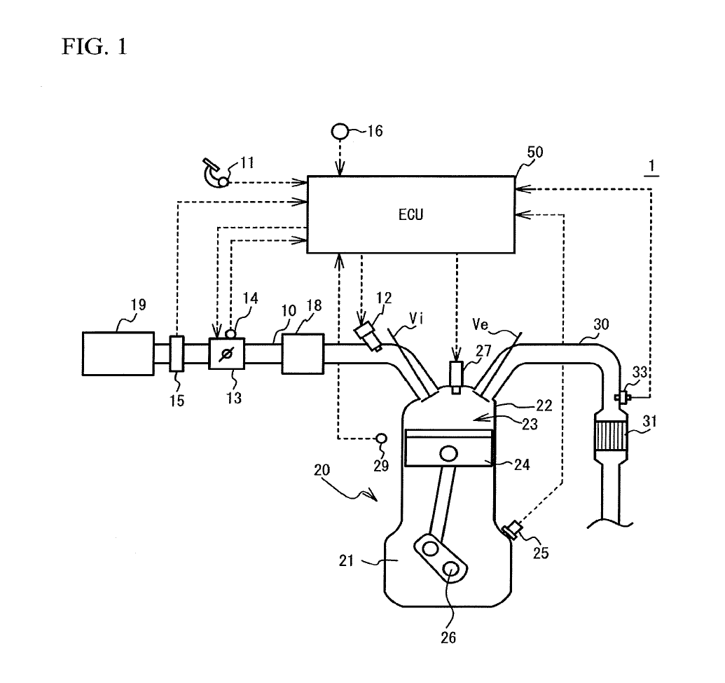

FIG. 1 is a schematic configuration diagram around an engine 20 in a vehicle 1. In the engine 20 burns the air-fuel mixture within a combustion chamber 23 in a cylinder head 22 arranged on a cylinder block 21 housing a piston 24, which causes the piston 24 to reciprocate. The reciprocating movement of the piston 24 is converted into the rotational movement of the crankshaft 26. Although the engine 20 is an in-line four-cylinder engine, it is not limited to this as long as it has multiple cylinders.

The cylinder head 22 of the engine 20 is provided with an intake valve Vi for opening and closing an intake port and an exhaust valve Ve for opening and closing an exhaust port for every cylinder. Also, the top of the cylinder head 22 is attached with an ignition plug 27 for igniting the air-fuel mixture in the combustion chamber 23 for every cylinder.

An intake port of each cylinder is connected to a surge tank 18 via a branch pipe of each cylinder. An intake pipe 10 is connected to an upstream side of the surge tank 18, and an air cleaner 19 is provided at an upstream end of the intake pipe 10. The intake pipe 10 is provided with an airflow meter 15 for detecting the intake air amount and with an electronically controlled throttle valve 13 in this order from the upstream side.

A fuel injection valve 12 for injecting fuel into the intake port is installed in the intake port of each cylinder. The fuel injected from the fuel injection valve 12 is mixed with the intake air, which makes an air-fuel mixture. This air-fuel mixture introduced into the combustion chamber 23 by opening the intake valve Vi is compressed by the piston 24, and then is ignited and burned by the ignition plug 27. Instead of the fuel injection valve 12 for injecting fuel into the intake port, there may be provided a fuel injection valve for directly injecting fuel into the cylinder, or respective fuel injection valves for injecting fuel into the intake port and into the cylinder.

On the other hand, the exhaust port of each cylinder is connected to an exhaust pipe 30 via a branch pipe of each cylinder. A three way catalyst 31 is provided on the exhaust pipe 30. The three way catalyst 31 has an oxygen storage capacity and purifies NOx, HC and CO. In the three-way catalyst 31, for example, one or more catalyst layers are formed on a base material such as cordierite, particularly a honeycomb base material. One or more catalyst layers include: a catalyst carrier such as alumina; and a catalyst metal such as platinum, palladium, rhodium or the like supported on the catalyst carrier. The three way catalyst 31 is an example of a catalyst for purifying an exhaust gas discharged from the multiple cylinders of the engine 20, and may be an oxidation catalyst or a gasoline particulate filter coated with an oxidation catalyst.

An air-fuel ratio sensor 33 for detecting the air-fuel ratio of the exhaust gas is arranged on the upstream side of the three-way catalyst 31. The air-fuel ratio sensor 33 that is a so-called wide range air-fuel ratio sensor is capable of continuously detecting an air-fuel ratio in a relatively wide range, and outputs signals proportional to the air-fuel ratio.

The vehicle 1 includes an ECU (Electronic Control Unit) 50. The ECU 50 includes a CPU (Central Processing Unit), a RAM (Random Access Memory), a ROM (Read Only Memory), a memory, and the like. The ECU 50 controls the engine 20 by executing a program stored in a ROM or a memory. Also, the ECU 50 is a controller of the vehicle 1, controls each device mounted on the vehicle 1, and executes temperature increase control as will be described later. The temperature increase control is achieved by a temperature increase request determinator, an engagement state determinator, an operation state determinator, and a resonance suppresser that are functionally achieved by the CPU, the ROM, and the RAM of the ECU 50. Details will be described later.

The ECU 50 is electrically connected to the above-described ignition plug 27, the throttle valve 13, the fuel injection valve 12, and the like. Further, the ECU 50 is electrically connected to an accelerator opening degree sensor 11 for detecting the accelerator opening degree, a throttle opening degree sensor 14 for detecting the throttle opening degree of the throttle valve 13, an airflow meter 15 for detecting the intake air quantity, a vehicle speed sensor 16, the air-fuel ratio sensor 33, a crank angle sensor 25 for detecting the crank angle of the crankshaft 26, a water temperature sensor 29 for detecting the temperature of the cooling water of the engine 20, and other various sensors, via an AD converter or the like. To ensure the desired output, the ECU 50 controls the ignition plug 27, the throttle valve 13, the fuel injection valve 12, and the like so as to control the ignition timing, the fuel injection amount, the fuel injection ratio, the fuel injection timing, the throttle opening degree, and the like, on the basis of the detection values of the various sensors and the like.

Next, a description will be given of the setting of the target air-fuel ratio by the ECU 50. When an temperature increase process described later stops, the target air-fuel ratio is set according to the driving state of the engine 20. For example, the target air-fuel ratio is set to be the stoichiometric air-fuel ratio when the driving state of the engine 20 falls in a low speed and low load region. The target air-fuel ratio is set to be richer than the stoichiometric air-fuel ratio when the driving state falls in the high speed and high load region. When the target air-fuel ratio is set, the fuel injection amount to each cylinder is feedback-controlled so that the air-fuel ratio detected by the air-fuel ratio sensor 33 coincides with the target air-fuel ratio.

In addition, the ECU 50 executes the temperature increase process for increasing a temperature of the three-way catalyst 31 to a predetermined temperature range. In the temperature increase process, the air-fuel ratio in at least one of the multiple cylinders is controlled to be a rich air-fuel ratio smaller than the stoichiometric air-fuel ratio, and each air-fuel ratio in the other cylinders is controlled to be a lean air-fuel ratio greater than the stoichiometric air-fuel ratio. This is a so-called dither control. Specifically, the fuel injection amount in one cylinder is correctly increased by a predetermined rate, as compared with the fuel injection amount corresponding to the above-mentioned target air-fuel ratio, thereby controlling the air-fuel ratio in one cylinder to be a rich air-fuel ratio. Each fuel injection amount in the other cylinders is correctly reduced by a predetermined rate, as compared with the fuel injection amount corresponding to the above-mentioned target air-fuel ratio, thereby controlling each air-fuel ratio in the other cylinders to be a lean air-fuel ratio.

For example, the air-fuel ratio in one cylinder is controlled to be a rich air-fuel ratio by correctly increasing the fuel injection amount corresponding to the target air-fuel ratio by 15%. Each air-fuel ratio in the other three cylinders is controlled to be a lean air-fuel ratio by correctly reducing the fuel injection amount by 5%. When the temperature increase process is executed in the above way, the surplus fuel discharged from the cylinder in which the rich air-fuel ratio is set adheres to the three-way catalyst 31, and burns in a lean atmosphere due to the exhaust gas discharged from the cylinder in which the lean air-fuel ratio is set. This increases the temperature of the three way catalyst 31. Also, in this embodiment, among the cylinders #1 to #4, the cylinder #1 is controlled to be a rich cylinder #1 in which the air-fuel ratio is rich, and the cylinders #2 to #4 are controlled to be lean cylinders #2 to #4 in which each air-fuel ratio is lean.

In the temperature increase process, the average of the air-fuel ratios in all of the cylinders is set to be the stoichiometric air-fuel ratio. However, the air-fuel ratio is not necessarily required to be the stoichiometric air-fuel ratio as long as the air-fuel ratio in a predetermined range including the stoichiometric air-fuel ratio is capable of increasing the temperature of the three-way catalyst 31 to its activation temperature and its regeneration temperature. For example, the rich air-fuel ratio is set between 9 and 12, and the lean air-fuel ratio is set between 15 and 16. Further, the air-fuel ratio in at least one of the multiple cylinders has only to be set to be the rich air-fuel ratio, and each air-fuel ratio in the other cylinders has only to be set to be the lean air-fuel ratio.

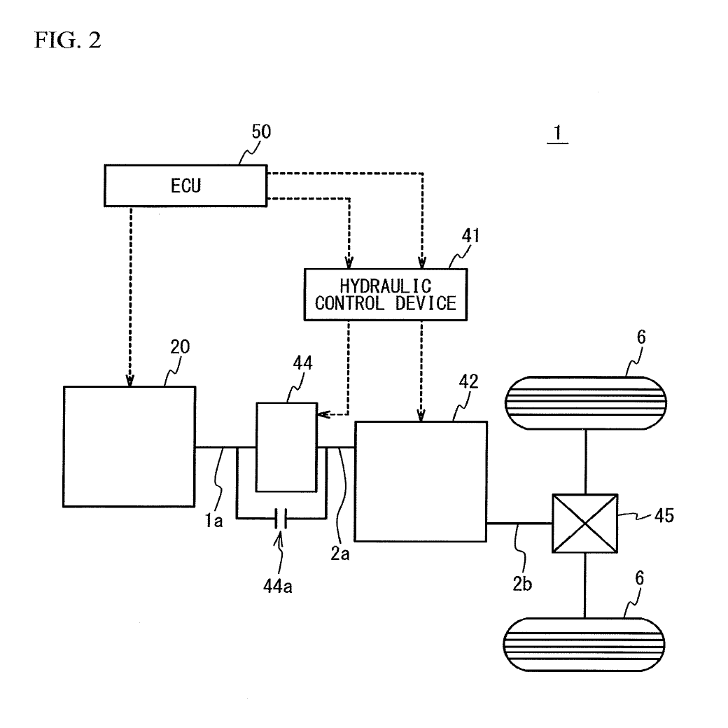

FIG. 2 is a schematic configuration view around an automatic transmission 42 of the vehicle 1. The vehicle 1 includes: a hydraulic control device 41; an automatic transmission 42; a torque converter 44; a differential gear 45; and drive wheels 6. The engine 20 converts the rotational energy of an output shaft 1a from the combustion energy of the fuel burned in the cylinders and outputs it.

The automatic transmission 42 is disposed on a power transmission path between the engine 20 and the drive wheels 6. Specifically, in the automatic transmission 42, an input shaft 2a is connected to the output shaft 1a of the engine 20 via the torque converter 44, and an output shaft 2b is connected to the left and right drive wheels 6 via the differential gear 45. The automatic transmission 42 changes the rotational speed of the output shaft 1a of the engine 20 and transmits it to the drive wheels 6.

The automatic transmission 42 is a step-type automatic transmission that stepwise changes a speed change ratio by switching engagement and disengagement of plural engagement devices in response to the action of the hydraulic pressure supplied from the hydraulic control device 41 controlled by the ECU 50. The above engagement devices are, for example, a clutch that connects the rotary elements to each other and a brake that regulates the rotation of the rotary elements.

The torque converter 44 is an example of a fluid transmission device that has a lock-up clutch 44a for controlling the power transmission to the automatic transmission 42 from the engine 20 by switching the engaged state and the disengaged state. Specifically, the torque converter 44 is provided between the engine 20 and the automatic transmission 42, and the lock-up clutch 44a is a friction engagement type clutch device provided between the output shaft 1a of the engine 20 and the input shaft 2a of the automatic transmission 42. The lock-up clutch 44a is controlled to be a fully engaged state, a slip engaged state, or a released state in response to the action of the hydraulic pressure supplied from the hydraulic control device 41 controlled by the ECU 50.

In the fully engaged state, the lock-up clutch 44a mechanically connects between the output shaft 1a of the engine 20 and the input shaft 2a of the automatic transmission 42 so that they rotate integrally without slipping. In the slip engaged state, the lock-up clutch 44a is brought into a slipping state with being not fully engaged. At this time, there is a rotational speed difference between the output shaft 1a of the engine 20 and the input shaft 2a of the automatic transmission 42 in accordance with the slip amount. In the released state, the torque converter 44 transmits the torque via the fluid.

The fully engaged state and the slip engaged state are an example of the engaged state. In this specification, the fully engaged state, the slip engaged state, and the released state of the lock-up clutch 44a are simply referred to as “fully engaged state”, “slip engaged state”, and “released state”, respectively. The state including both of the fully engaged state and the slip engaged state is simply referred to as “engaged state”.

The ECU 50 calculates required output of the engine 20 for achieving a request such as acceleration required by a driver of the vehicle 1 on the basis of the vehicle speed detected by the vehicle speed sensor 16 and on the accelerator opening degree based on the driver's operation detected by the accelerator opening degree sensor 11. The ECU 50 calculates plural operating points of the engine 20 to achieve the calculated required output, in reference to a gear shift map (not illustrated) indicating a gear position pattern of the automatic transmission 42 according to the vehicle speed and the accelerator opening degree. The plural operating points are calculated corresponding to plural gear positions that the automatic transmission 42 is capable of taking. Note that the gear shift map is stored in the memory of the ECU 50.

The ECU 50 calculates and compares the fuel consumption amount of the engine 20 at each of the plural calculated operating points, determines an operating point at which the calculated fuel consumption amount is minimum, and controls the engine 20 and the automatic transmission 42 so as to achieve a combustion state and a gear shift ratio corresponding to the determined operating point.

The ECU 50 controls the state of the lock-up clutch 44a of the torque converter 44. The ECU 50 refers to a control map (not illustrated) defining the control pattern of the lock-up clutch 44a at each gear position of the automatic transmission 42 in accordance with the vehicle speed and the torque of the output shaft 1a of the engine 20, and calculates the state of the lock-up clutch 44a at each calculated operating point. In addition, the control map is stored in the memory of the ECU 50.

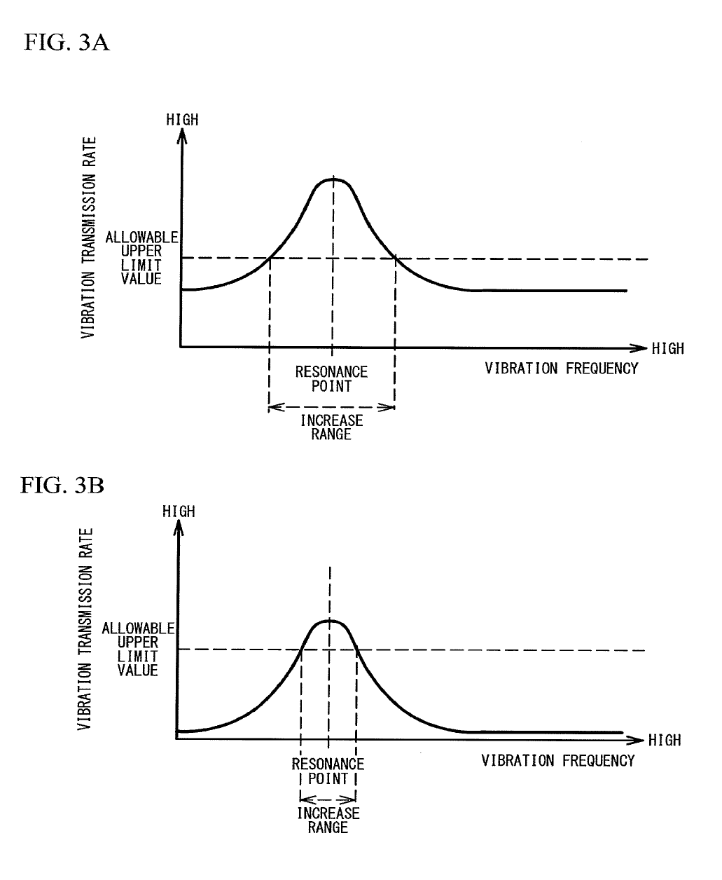

Next, a description will be given of a vibration transmission rate from the engine 20 to the automatic transmission 42 in the engaged state. FIG. 3A and FIG. 3B are graphs illustrating the vibration transmission rate from the engine 20 to the automatic transmission 42 with respect to a vibration frequency of the engine 20 in the fully engaged state and in the slip engaged state, respectively. A vertical axis indicates the vibration transmission rate from the engine 20 to the automatic transmission 42. A horizontal axis indicates the vibration frequency of the engine 20. In any state, the vibration transmission rate increases, as the vibration frequency of the engine 20 approaches the resonance point of the automatic transmission 42 and the engine 20. That is, the engine 20 resonates with the automatic transmission 42. Further, the vibration transmission rate is larger in the fully engaged state than in the slip engaged state. An increase range of the vibration frequency, in which a vibration transmission rate is higher than a common allowable upper limit value, is wider in the fully engaged state than in the slip engaged state.

Here, the engine 20 has four cylinders and the ignition is performed four times in total during one combustion cycle. Thus, the rotational speed of the engine 20 temporarily increases, when the fuel is ignited in each cylinder. Therefore, the rotational speed fluctuation is caused by four ignitions during one combustion cycle. However, the rich cylinder #1 and the lean cylinders #2 to #4 are achieved by executing the temperature increase process, so that the rotational speed of the engine 20 temporarily increases due to the ignition in the rich cylinder #1. For this reason, the vibration frequency component of the first older vibration per one cycle increases during the temperature increase process, as compared with during stopping of the temperature increase process.

For example, when the rotational speed of the in-line four-cylinder engine 20 is 1200 rpm in the present embodiment, the engine 20 rotates 20 times per second, and ignition is performed four times while the engine 20 rotates twice. Thus, the vibration frequency of the engine 20 is 40 Hz. When the temperature increase process is executed in this state, the vibration frequency of 10 Hz is generated by the ignition in the rich cylinder #1, since the vibration caused by the ignition in the rich cylinder #1 is larger than the vibration caused by each ignition in the other lean cylinders #2 to #4. If 10 Hz falls in the increase range illustrated in FIG. 3A or FIG. 3B, the engine 20 resonating with the automatic transmission 42 might increase the vibration, so the drivability might deteriorate. Therefore, when the vibration frequency of the engine 20 caused by the execution of the temperature increase process falls in the increase range so that the engine 20 resonating with the automatic transmission 42 might increase the vibration, the ECU 50 executes a resonance suppression process for suppressing the resonance by controlling the temperature increase process. The resonance suppression process will be described later in detail. Additionally, since the power transmission is disconnected between the engine 20 and the automatic transmission 42 in the released state, the vibration transmission rate is zero. Further, the resonance points are different from each other depending on a gear position.

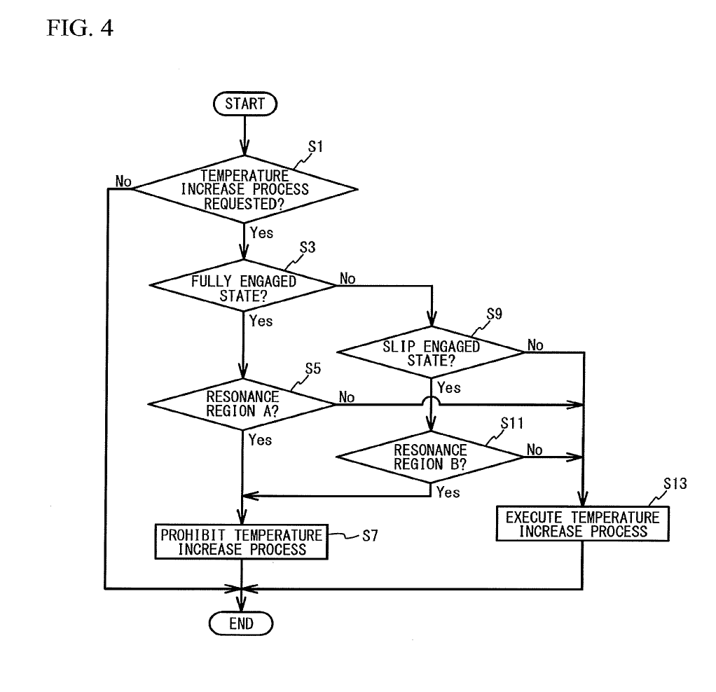

FIG. 4 is a flowchart illustrating the temperature increase control in the present embodiment. The flowchart of FIG. 4 is repeatedly executed by the ECU 50 at predetermined intervals. First, it is determined whether or not there is a request to execute the temperature increase process (step S1). Specifically, the ECU 50 makes the determination based on whether or not an execution request flag of the temperature increase process is ON. Incidentally, the execution request flag of the temperature increase process is turned ON, when there is a request for warming up the three-way catalyst 31 at the time of cold start, a request for increasing a temperature of the three-way catalyst 31 up to an activation temperature thereof, or a request for increasing a temperature of the three-way catalyst 31 up to a regeneration temperature thereof. The process of step S1 is an example of a process executed by the temperature-increase request determinator configured to determinate whether or not to request the temperature increase process that increases a temperature of the three-way catalyst 31 by controlling an air-fuel ratio in at least one cylinder of a plurality of the cylinders of the engine 20 to be a rich air-fuel ratio smaller than the stoichiometric air-fuel ratio and controlling an air-fuel ratio in a cylinder other than the at least one cylinder to be a lean air-fuel ratio greater than the stoichiometric air-fuel ratio. When a negative determination is made in step S1, the process is finished.

When an affirmative determination is made in step S1, it is determined whether or not the fully engaged state is established (step S3). Specifically, on the basis of a target value of the hydraulic pressure based on the lock-up clutch 44a controlling a state of the hydraulic control device 41, it is determined whether or not the engaged state is the fully engaged state. The process of step S3 is an example of a process executed by the engagement state determinator configured to determine whether or not the lock-up clutch 44a is in the engaged state.

When an affirmative determination is made in step S3, it is determined whether or not the rotational speed of the engine 20 falls in an resonance region A (step S5). The resonance region A is a rotational speed range of the engine 20 in which the resonance of the engine 20 and the automatic transmission 42 increases vibration at the time when the temperature increase process is executed in the fully engaged state. Specifically, the resonance region A according to a gear position is a predetermined rotational speed range including the resonance rotational speed of the engine 20 at which the engine 20 resonates with the automatic transmission 42 at the time when the temperature increase process is executed in the fully engaged state. The process of step S5 is a process executed by the driving state determinator configured to determine whether or not rotational speed of the engine 20 falls in the resonance region A in which the engine 20 resonates with the automatic transmission 42 if the temperature increase process is executed, when an affirmative determination is made in step S3.

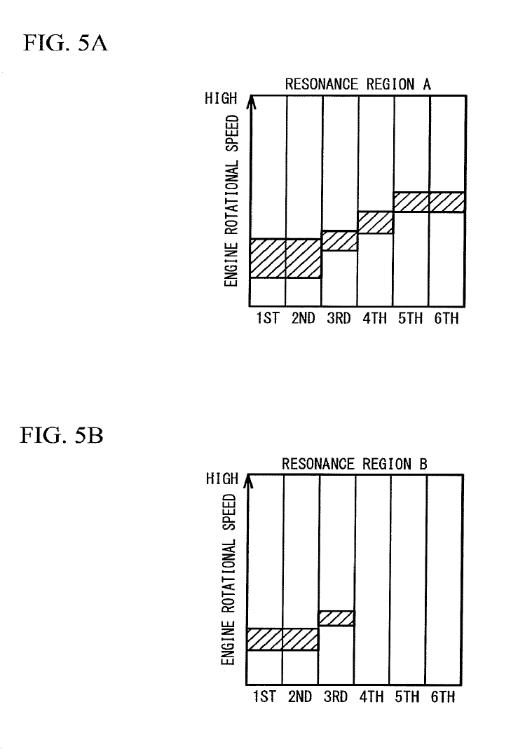

FIG. 5A is an example of a map defining the resonance region A. This map is experimentally obtained beforehand and stored in the memory of the ECU 50. A vertical axis indicates the engine rotational speed. A horizontal axis indicates the gear position. In FIG. 5A, a hatched area corresponds to the resonance region A. In the resonance region A defined by the map of FIG. 5A, the rotational speed of the engine 20 increases as the gear position increases, but this map is merely an example and is not limited. This is because a driving range in which the execution of the temperature increase process increases the vibration of the engine 20 and the automatic transmission 42 varies depending on the structure of the lock-up clutch 44a, the automatic transmission 42, and the like.

When an affirmative determination is made in step S5, the execution of the temperature increase process is prohibited (step S7). This suppresses an increase in the vibration of the engine 20 and the automatic transmission 42. This also suppresses deterioration of the drivability and deterioration of determination accuracy such as misfire determination based on the rotational fluctuation amount of the engine 20, and air-fuel ratio imbalance abnormality determination. The process of step S7 is a process executed by the resonance suppressor configured to control the temperature increase process to execute a resonance suppression process suppressing the resonance of the engine 20 and the automatic transmission 42 caused by the execution of the temperature increase process, when affirmative determinations are made in steps S1, S3, and S5, or when affirmative determinations are made in steps S1, S9, and S11.

When a negative determination is made in step S3, it is determined whether or not the slip engaged state (step S9) is established. Even in this case, it is determined based on the target value of the hydraulic pressure for controlling the state of the automatic transmission 42. The process of step S9 is an example of a process executed by the engagement state determinator configured to determine whether or not the lock-up clutch 44a is in the engaged state.

When an affirmative determination is made in step S9, it is determined whether or not the driving state of the engine 20 falls in a resonance region B (step S11). The resonance region B is a rotational speed range of the engine 20 in which the resonance of the engine 20 and the automatic transmission 42 increases vibration at the time when the temperature increase process is executed in the slip engaged state. Specifically, the resonance region B according to a gear position is a predetermined rotational speed range including the resonance rotational speed of the engine 20 at which the engine 20 resonates with the automatic transmission 42 at the time when the temperature increase process is executed in the slip engaged state. The process of step S11 is an example of a process executed by the driving state determinator configured to determine whether or not rotational speed of the engine 20 falls in the resonance region B in which the engine 20 resonates with the automatic transmission 42 if the temperature increase process is executed, when an affirmative determination is made in step S9.

FIG. 5B is an example of a map defining the resonance region B. This map is experimentally obtained beforehand and stored in the memory of the ECU 50. A vertical axis indicates the engine rotational speed. A horizontal axis indicates the gear position. In FIG. 5B, a hatched area corresponds to the resonance region B. The resonance region B defined by the map of FIG. 5B defines only the gear positions from 1st to 3rd. This is because the vibration transmission rate from the engine 20 to the automatic transmission 42 is small and the engine 20 hardly resonates with the automatic transmission 42 in the slip engaged state, as compared with the fully engaged state. The map of FIG. 5B is merely an example, and the resonance region B is not limited to this.

When an affirmative determination is made in step S11, the execution of the temperature increase process is prohibited (step S7). Thus, even in the slip engaged state, the resonance of the engine 20 and the automatic transmission 42 is suppressed.

When a negative determination is made in any one of steps S5 and S11, the temperature increase process is executed (step S13). This can suitably increase the temperature of the three way catalyst 31, when the engine 20 does not resonate with the automatic transmission 42.

Also, when a negative determination is made in step S9, that is, even in the released state, the temperature increase process is also executed (step S13). This is because there is no possibility that the engine 20 resonates with the automatic transmission 42 in the released state as described above.

As explained heretofore, the execution of the temperature increase process is prohibited when the engine 20 is likely to resonate with the automatic transmission 42 by executing the temperature increase process, and the temperature increase process is executed when the resonance does not occur. This suppresses the resonance of the engine 20 and the automatic transmission 42 and the deterioration of the drivability, and also ensures the effectiveness of the temperature increase process.

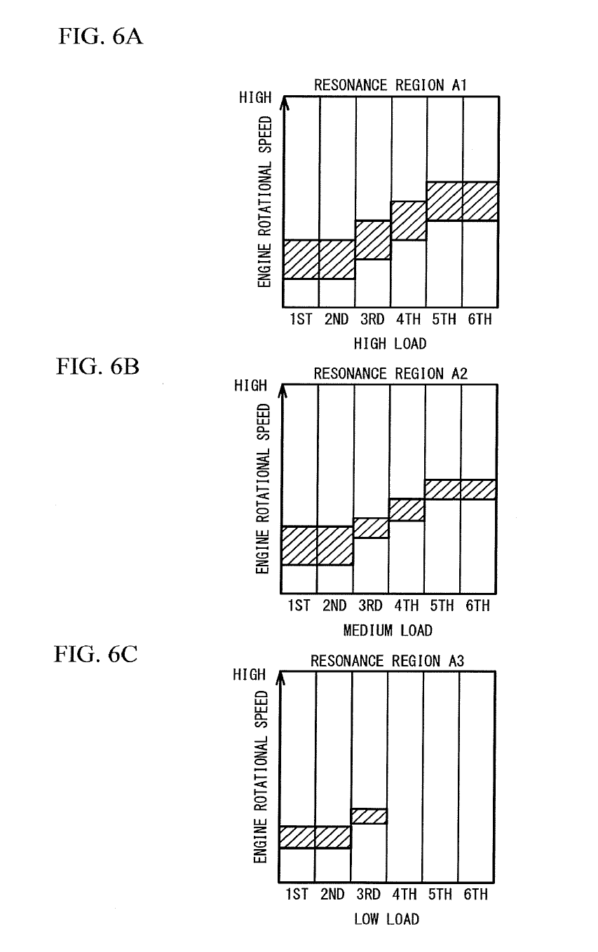

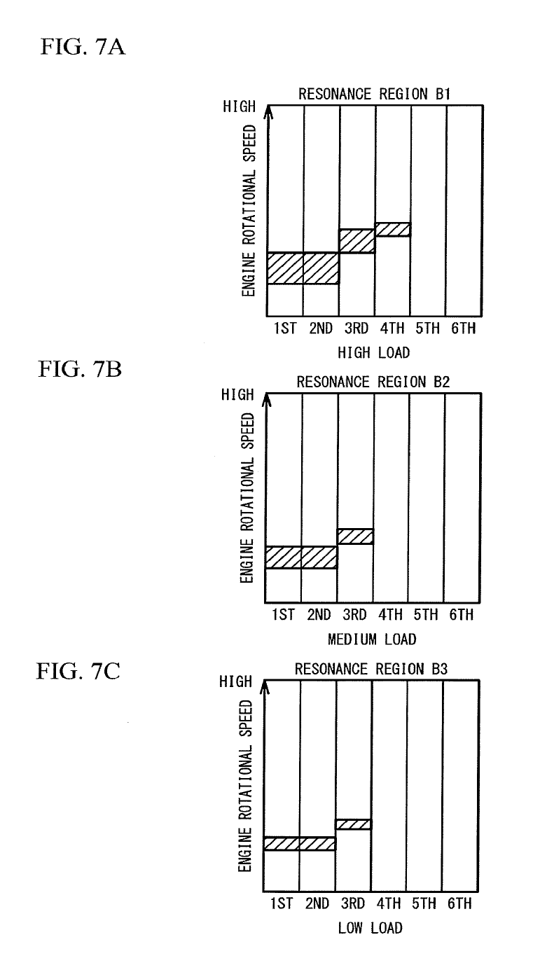

Next, plural variations will be described. In the first variation, the above-described resonance regions A and B are switched therebetween in accordance with load of the engine 20. FIG. 6A to FIG. 6C are maps defining resonance regions A1 to A3 corresponding to the loads of the engine 20 in the fully engaged state. FIG. 7A to FIG. 7C are maps defining resonance regions B1 to B3 corresponding to the loads of the engine 20 in the slip engaged state. FIG. 6A to FIG. 6C are maps defining the resonance regions A1 to A3 for high load, medium load, and low load of the engine 20, respectively. FIG. 7A to FIG. 7C are maps defining the resonance regions B1 to B3 for the high load, the medium load, and the low load of the engine 20, respectively. These maps are stored in the memory of the ECU 50 in advance.

Since there is a high possibility that the vibration of the engine 20 and the automatic transmission 42 increase as the load of the engine 20 increases, the resonance region A1 for the high load state is wider than the resonance region A2 for the medium load state, and the resonance region A2 for the medium load state is wider than the resonance region A3 for the low load state. Similarly, the resonance region B1 is wider than the resonance region B2, and the resonance region B2 is wider than the resonance region B3. Considering not only the gear position but also the load of the engine 20 in this way, it is possible to accurately determine whether or not the rotational speed of the engine 20 falls in the resonance region.

In addition, the load of the engine 20 is obtained based on, for example, a detection value of the airflow meter 15. Further, only one of the resonance regions A and B may be switched according to the load of the engine 20 as described above.

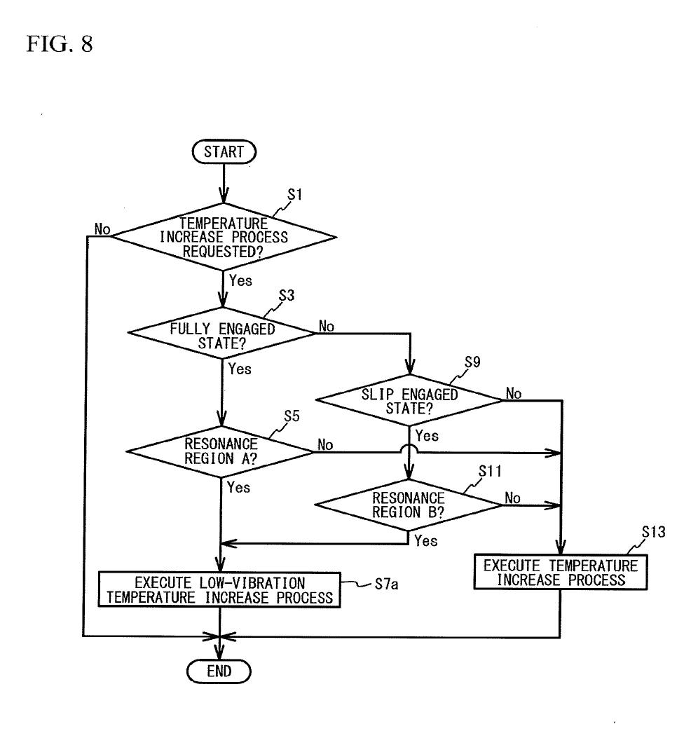

Next, the second variation will be described. In temperature increase control in the second variation, the resonance suppression process is executed by controlling the temperature increase process with a different method from the above embodiment. FIG. 8 is a flowchart illustrating the temperature increase control in the second variation. Additionally, same processes in the above embodiment will be denoted with same reference numerals, and duplicate description will be omitted. When an affirmative determination is made in step S5 or S11, a low-vibration temperature increase process is executed (step S7a). The process of step S7a is an example of the resonance suppress process suppressing the resonance of the engine 20 and the automatic transmission 42 caused by execution of the temperature increase process by decreasing a difference between the rich air-fuel ratio and the lean air-fuel ratio as compared with the released state and by executing the temperature increase process, when affirmative determinations are made in steps S1, S3, and S5, or when affirmative determinations are made in steps S1, S9, and S11.

The low-vibration temperature increase process is a temperature increase process in which the vibration of the engine 20 is suppressed as compared with the temperature increase process executed in step S13 (hereinafter referred to as “normal temperature increase process” in the description of the second variation and in the later description of the third variation). Specifically, the low-vibration temperature increase process is a temperature increase process in which the vibration of the engine 20 is suppressed by decreasing the difference between the rich air-fuel ratio and the lean air-fuel ratio as compared with the normal temperature increase process.

For example, in the case where the rich air-fuel ratio and the lean air-fuel ratio are respectively achieved based on the increase correction increasing the fuel injection amount by 15% and on the decrease correction decreasing the fuel injection amount by 5% in the normal temperature increase process as described above, the rich air-fuel ratio and the lean air-fuel ratio are respectively achieved based on the increase correction increasing the fuel injection amount by, for example, 9% and on the decrease correction decreasing the fuel injection amount by, for example, 3% in the low-vibration temperature increase process. This suppresses the vibration caused by the ignition in the rich cylinder #1, thereby suppressing the vibration of the engine 20. It is therefore possible to increase the temperature of the three way catalyst 31 while the engine 20 is suppressed from resonating with the automatic transmission 42 even in the engaged state.

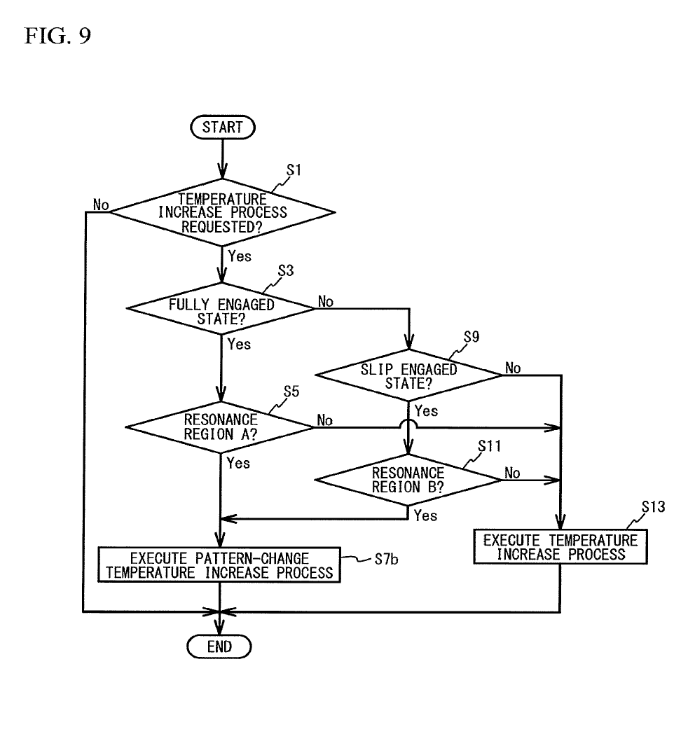

Next, the third variation will be described. In temperature increase control in the third variation, the temperature increase control executes the resonance suppression process by controlling the temperature increase process with a different method from the first and second variations described above. FIG. 9 is a flowchart illustrating the temperature increase control in the third variation. When an affirmative determination is made in step S5 or S11, a pattern-change temperature increase process is executed (step S7b). The process of step S 7b is an example of the resonance suppress process suppressing the resonance of the engine 20 and the automatic transmission 42 caused by execution of the temperature increase process by changing a combination of the plural cylinders in which the rich air-fuel ratio and the lean air-fuel ratio are respectively achieved and by executing the temperature increase process, when affirmative determinations are made in steps S1, S3, and S5, or when affirmative determinations are made in steps S1, S9, and S11.

The pattern-change temperature increase process is the temperature increase process executed by changing a combination pattern of the rich cylinder and the lean cylinder such that the vibration frequency of the engine 20 caused by the execution of the temperature increase process deviates from the resonance point of the engine 20. Specifically, in the pattern-change temperature increase process, the temperature increase process is executed by changing the combination pattern of the rich cylinder and the lean cylinder that are achieved in the normal temperature increase process. For example, although the rich cylinder #1 and the lean cylinders #2 to #4 are achieved in the normal temperature increase process described above, for example, the rich cylinders #1 and #4 and the lean cylinders #2 and #3 are achieved in the pattern-change increase process.

As described above, in the normal temperature increase process, the vibration frequency component of the first older vibration per one cycle increases. Since the rich cylinders #1 and #4 are achieved in the above-described pattern-change increase process, the vibration frequency component of the first order vibration per one cycle decreases, and the vibration frequency component of the second order vibration per one cycle increases, as compared with the normal temperature increase process.

For example, when the normal temperature increase process is executed with the engine speed of the engine 20 being 1200 rpm, the vibration of 10 Hz of the vibration frequency caused by the rich cylinder #1 may increase, so this vibration frequency may fall in the increase range illustrated in FIG. 3A or 3B. In contrast, in the pattern-change increase process, the vibration frequency caused by the rich cylinders #1 and #4 is 20 Hz, and the vibration frequency component of 10 Hz decreases. It is thus possible to increase the temperature of the three way catalyst 31 while the resonance of the engine 20 and the automatic transmission 42 is suppressed.

Incidentally, in the case where the rich cylinder #1 and the lean cylinders #2 to #4 are respectively achieved based on the increase correction increasing the fuel injection amount by 15% and on the decrease correction decreasing the fuel injection amount by 5% in the normal temperature increase process, the rich cylinders #1 and #4 and the lean cylinders #2 and #3 are respectively achieved based on the increase correction increasing the fuel injection amount by 5% and on the decrease correction decreasing the fuel injection amount by 5% in the pattern-change temperature increase process.

A description will be given of a pattern-change increase process in the case of employing a V-type six-cylinder engine instead of the engine 20 of the in-line four-cylinder engine. As for the V-type six-cylinder engine, the cylinders #1, #3, and #5 are provided in one bank, the cylinders #2, #4, and #6 are provided in the other bank, and the ignition is performed in the cylinders #1 to #6 in this order. In the normal temperature increase process, the rich cylinders #3 and #6 and the lean cylinders #1, #2, #4, and #5 are achieved. Thus, the second-order vibration frequency component caused by the ignition in the rich cylinders #3 and #6 increases. Here, it is assumed that the second-order cycle frequency belongs to the above-mentioned increase range.

In the pattern-change temperature increase process, for example, the rich cylinders #1 to #3 and the lean cylinders #4 to #6 are achieved. Thus, since the ignition is continuously performed in the rich cylinders #1 to #3, the vibration frequency component of the first order per one cycle increases, but the vibration frequency component of the second older per one cycle decreases, as compared to the normal temperature increase process. In the case of the resonance of the engine 20 and the automatic transmission 42 caused by executing the normal temperature increase process in this manner, the pattern-change normal temperature increase process is executed, whereby the temperature of the three way catalyst 31 increases while the resonance of the engine 20 and the automatic transmission 42 is suppressed.

In the pattern-change increase process for the V-type six-cylinder engine, the rich cylinders #1 and #2 and the lean cylinders #3 to #6 may be achieved, or the rich cylinders #4 and #5 and the lean cylinders #1 and #2 may be achieved and the cylinders #3 and #6 may be controlled to each have the stoichiometric air-fuel ratio. Even in these cases, this is because the vibration frequency component of the second order vibration per one cycle can decrease as compared with the normal temperature increase process.

Further, in the V-type six-cylinder engine in which exhaust pipes and catalysts are provided corresponding to the respective banks, a state may be switched, every combustion cycle, between a state of the rich cylinder #1, the lean cylinders #3 and #5, and the cylinders #2, #4, and #6 controlled to each have the stoichiometric air-fuel ratio, and a state of the rich cylinder #2, the lean cylinders #4 and #6, and the cylinders #1, #3, and #5 controlled to each have the stoichiometric air-fuel ratio. In this case, since the rich cylinder is changed every combustion cycle, the vibration frequency component of the second order vibration per one cycle can decrease as compared with the normal temperature increase process. Alternatively, a state may be switched, every combustion cycle, between a state of the rich cylinders #2, #4, and #6, and the lean cylinders #1, #3, and #5, and a state of the rich cylinders #1, #3, and #5, and the lean cylinders #2, #4, and #6.

Further, in the V-type six-cylinder engine in which an exhaust pipe and a catalyst are in common use for banks, the rich cylinder #1, the lean cylinders #3 and #5, and the cylinders #2, #4, and #6 controlled to each have the stoichiometric air-fuel ratio may be achieved, or the rich cylinders #1, #3, and #5 and the lean cylinders #2, #4, and #6 may be achieved. Although the vibration frequency component of the first or third order vibration per one cycle might increase, the vibration frequency component of the second order vibration per one cycle can decrease as compared with the normal temperature increase process.

A description will be given of a pattern-change increase process for an in-line six-cylinder engine employed instead of the in-line four-cylinder engine 20. As for the in-line six-cylinder engine, the ignition is performed in the cylinders #1, #5, #3, #6, #2, and #4 in this order. In a normal temperature increase process, the rich cylinders #3 and #4 and the lean cylinders #1, #2, #5, and #6 are achieved. Thus, the vibration frequency component of the second order vibration per one cycle increases due to ignition in the rich cylinders #3 and #4. On the other hand, in the pattern-change increase process, for example, the rich cylinders #1, #3, and #5 and the lean cylinders #2, #4, and #6 are achieved. Therefore, since the ignition is performed continuously in the rich cylinders #1, #5, and #3, the vibration frequency component of the second order vibration per one cycle can decrease as compared with the normal temperature increase process. This also makes it possible to increase the temperature of the three-way catalyst 31 while the resonance of the engine 20 and the automatic transmission 42 is suppressed.

Incidentally, the pattern-change increase process for the in-line six-cylinder engine is not limited to the above example. For example, the rich cylinders #1 and #5 and the lean cylinders #2 to #4 and #6 may be achieved, or the rich cylinders #2 and #6 the lean cylinders #1 and #5, and the cylinders #3 and #4 controlled to each have the stoichiometric air-fuel ratio may be achieved. Even in these cases, this is because the vibration frequency component of the second order vibration per one cycle can decrease as compared to the normal temperature increase process. Further, the rich cylinder #1, the lean cylinders #2 and #3, and the cylinders #4 to #6 controlled to each have the stoichiometric air-fuel ratio may be achieved. Although the vibration frequency component of the first order vibration per one cycle might increase due to ignition in the rich cylinder #1 as compared with the normal temperature increase process, the vibration frequency component of the second order vibration per one cycle can decrease. Additionally, the rich cylinders #1, #3, and #5 and the lean cylinders #2, #4, and #6 may be achieved.

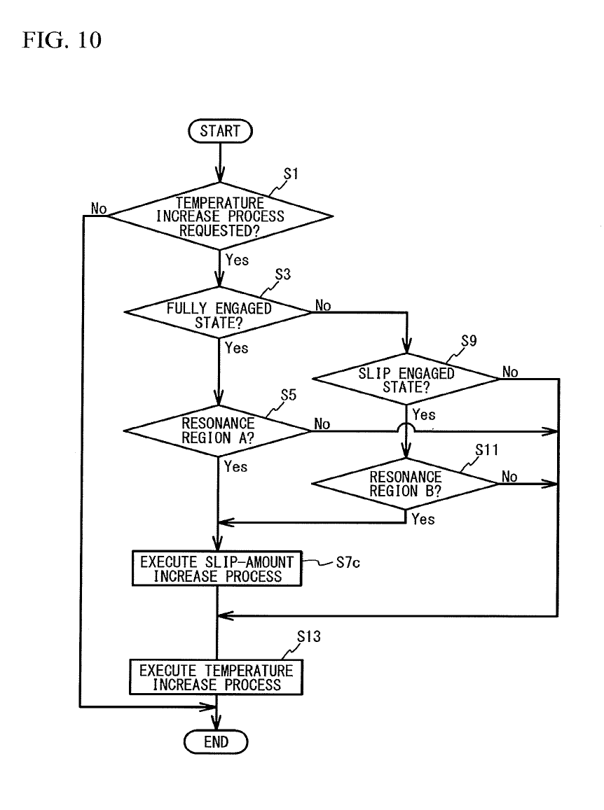

Next, the fourth variation will be described. In temperature increase control in the fourth variation, the resonance suppression process for suppressing the resonance of the engine 20 and the automatic transmission 42 caused by the execution of the temperature increase process is executed by controlling the slip amount of the lock-up clutch 44a. FIG. 10 is a flowchart illustrating the temperature increase control in the fourth variation. When an affirmative determination is made in step S5 or S11, a slip-amount increase process is executed (step S7c), and the temperature increase process is executed (step S13). The processes in steps S7c and S13 are an example of the resonance suppress process that increases the slip amount of the lock-up clutch 44a, as compared with a slip amount in which the processes in steps S7c and S13 are not executed, and executes the temperature increase process, when the affirmative determinations are made in steps S1, S3, and S5, or when the affirmative determinations are made in steps S1, S9, and S11.

The slip-amount increase process is a process for increasing the slip amount of the lock-up clutch 44a only by a constant amount and is performed by adjusting the oil pressure value controlled by the hydraulic control device 41. When an affirmative determination is made in steps S3 and S5 and the process in step S7c is executed, the slip amount is increased in the fully engaged state, so that the fully engaged state is changed into the slip engaged state. Thus, the transmission rate of the vibration from the engine 20 to the automatic transmission 42 decreases, and the resonance of the engine 20 and the automatic transmission 42 in executing the temperature increase process is suppressed.

When an affirmative determination is made in steps S9 and S11 and the process in step S7c is executed, the slip amount is increased in the slip engaged state, so that the slip engaged state is changed into the released state. Since the temperature increase process is executed in the released state, the resonance of the engine 20 and the automatic transmission 42 is suppressed.

The fully engaged state may be changed into the released state by the slip-amount increase process described above. Further, the slip amount may be increased by the slip-amount increase process while the slip engaged state is maintained. In either case, the resonance of the engine 20 and the automatic transmission 42 at the time of executing the temperature increase process is suppressed.

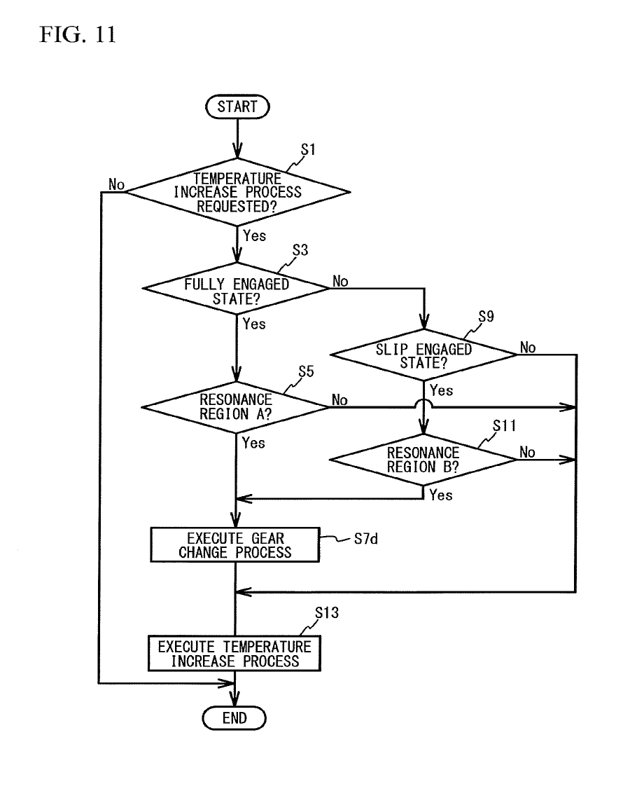

Next, the fifth variation will be described. In temperature increase control in the fifth variation, the resonance suppression process for suppressing the resonance of the engine 20 and the automatic transmission 42 caused by the execution of the temperature increase process is executed by controlling the gear position of the automatic transmission 42. FIG. 11 is a flowchart illustrating the temperature increase control in the fifth variation. When an affirmative determination is made in any one of steps S5 and S11, a gear change process is executed (step S7d), and the temperature increase process is executed (step S13). The processes in steps S7d and S13 are an example of the resonance suppress process that changes a gear position of the automatic transmission 42 and executes the temperature increase process such that the driving state deviates from the resonance regions A and B, when affirmative determinations are made in step S1, S3, and S5 or in step S1, S9, and S11.

Specifically, in the fully engaged state, the gear change process is a process for changing the current gear position into a different gear position such that the driving state of the engine 20 deviates from the resonance region A. In the slip engaged state, the gear change process is a process for changing the current gear position into a different gear position such that the driving state of the engine 20 deviates from the resonance region B. For example, the current gear position is changed into a higher or lower gear position by one step.

For example, when the gear position is 3rd gear and the driving state of the engine 20 falls in the resonance region A illustrated in FIG. 5A, the gear position is changed into 2nd or 4th gear position. When the gear position is changed from 3rd gear position into 2nd gear position, the rotational speed of the engine 20 increases, so the driving state of the engine 20 can deviate from the resonance region A. When the gear position is changed from 3rd gear position into 4th gear position, the rotational speed of the engine 20 decreases, so the driving state of the engine 20 can deviate from the resonance region A. Since the temperature increase process is executed after the driving state of the engine 20 deviates from the resonance region A in this manner, the temperature of the three-way catalyst 31 can increase while the resonance of the engine 20 and the automatic transmission 42 is suppressed. The same applies to the case where the driving state of the engine 20 falls in the resonance region B in the slip engaged state.

Moreover, if the driving state of the engine 20 falls in the resonance region A even after the gear change process changes the current gear position into the higher gear position by one step in the fully engaged state, the gear position may be further changed to the higher gear position by one step. If the driving state of the engine 20 falls in the resonance region A even after the gear change process changes the current gear position into the lower gear position by one step, the gear position may be further changed to the lower gear position by one step. This also applies to the slip engaged state.

Although the automatic transmission 42 is needed in the fifth variation, a manual transmission may be used in place of the automatic transmission 42 in the first to fourth variations. Like the first variation, the resonance suppression process may be executed based on the resonance regions A1 to A3 and B1 to B3 corresponding to the load of the engine 20 in the second to fifth variations.

Although some embodiments of the present invention have been described in detail, the present invention is not limited to the specific embodiments but may be varied or changed within the scope of the present invention as claimed.

For example, the temperature increase process may be executed with the slip-amount increase process in the fourth variation in addition to the low-vibration temperature increase process in the second variation described above.

In the above embodiment, the rich air-fuel ratio and the lean air-fuel ratio are achieved in the temperature increase process on the basis of the increase correction or the decrease correction with respect to the fuel injection quantity achieving the target air-fuel ratio, but this is not limited. That is, in the temperature increase process, the target air-fuel ratio of any one of the cylinders may be set to the rich air-fuel ratio, and the target air-fuel ratio of the other cylinders may be set directly to the lean air-fuel ratio.

What is claimed is:

1. A control device for a vehicle, the vehicle comprising an internal combustion engine, a transmission disposed on a power transmission path between the internal combustion engine and a driving wheel, a fluid transmission device including a lock-up clutch switching between an engaged state and a released state to control power transmission from the internal combustion engine to the transmission, and a catalyst for purifying exhaust gas from the internal combustion engine, the control device comprising:
a temperature-increase request determinator configured to determinate whether or not to request a temperature increase process that increases a temperature of the catalyst by controlling an air-fuel ratio in at least one cylinder of a plurality of cylinders of the internal combustion engine to be a rich air-fuel ratio smaller than a stoichiometric air-fuel ratio and by controlling an air-fuel ratio in a cylinder other than the at least one cylinder to be a lean air-fuel ratio greater than the stoichiometric air-fuel ratio;
an engagement state determinator configured to determine whether or not the lock-up clutch is in the engaged state;
a driving state determinator configured to determine whether or not rotational speed of the internal combustion engine falls in a resonance region in which the internal combustion engine resonates with the transmission if the temperature increase process is executed, when an affirmative determination is made by the engagement state determinator; and
a resonance suppressor configured to control any one of the temperature increase process, a slip amount of the lock-up clutch, and a gear position of the transmission to execute a resonance suppression process suppressing resonance of the internal combustion engine and the transmission caused by execution of the temperature increase process, when affirmative determinations are made by the temperature-increase request determinator, the engagement state determinator, and the driving state determinator.

2. The control device for the vehicle according to claim 1, wherein the resonance suppress process is any one of a process that prohibits execution of the temperature increase process, a process that decreases a difference between the rich air-fuel ratio and the lean air-fuel ratio as compared with the released state and executes the temperature increase process, and a process that changes a combination of the plurality of the cylinders in which the rich air-fuel ratio and the lean air-fuel ratio are respectively achieved and executes the temperature increase process such that a vibration frequency of the internal combustion engine caused by the execution of the temperature increase process deviates from a resonance point of the internal combustion engine.

3. The control device for the vehicle according to claim 1, wherein the resonance suppress process is a process that increases the slip amount of the lock-up clutch, as compared with a slip amount in which the resonance suppress process is not executed, and executes the temperature increase process.

4. The control device for the vehicle according to claim 1, wherein the resonance suppress process is a process that changes a gear position of the transmission and executes the temperature increase process such that rotational speed of the internal combustion engine deviates from the resonance region.

5. The control device for the vehicle according to claim 1, wherein the resonance region is different according to a gear position of the transmission.

6. The control device for the vehicle according to claim 1, wherein the resonance region is expanded as a load of the internal combustion engine increases.

7. The control device for the vehicle according to claim 1, wherein
the engagement state includes a fully engaged state and a slip engaged state and,
the resonance region is larger in the fully engaged state than in the slip engagement state.
